(19) United States
(12) Patent Application Publication
(10) Pub. No.: US 2010/0209329 A1
(43) Pub. Date: Aug. 19, 2010

(54) CATALYST FOR PRODUCING AMMONIA FROM HYDROCARBON AND NITROGEN OXIDES

(75) Inventors: Howard FURBECK, Hamilton, NJ (US); Gerald S. Koermer, Basking Ridge, NJ (US); Ahmad Moini, Princeton, NJ (US); Steven J. Schmieg, Troy, MI (US)

Correspondence Address: BASF CATALYSTS LLC, 100 CAMPUS DRIVE, FLORHAM PARK, NJ, 07932, US

(73) Assignee: BASF Catalysts LLC, Florham Park, NJ (US)

(21) Appl. No.: 12/695,598

(22) Filed: Jan. 28, 2010

Related U.S. Application Data
(60) Provisional application No. 61/177,160, filed on May 11, 2009.
(60) Provisional application No. 61/148,899, filed on Jan. 30, 2009.

(51) Int. Cl. C01C 1/12

(52) U.S. Cl. 423/352

(57) ABSTRACT

Provided is a process for producing ammonia by the catalytic reduction of nitrogen oxide in the presence of a hydrocarbon, and in certain embodiments, in the presence of an oxygenated hydrocarbon.

### CROSS-REFERENCE TO RELATED APPLICATIONS

This application claims the benefit pursuant to 35 U.S.C. §119(e) of U.S. Provisional Application Nos. 61/177,160, filed May 11, 2009, and 61/148,899, filed Jan. 30, 2009; each of which is hereby incorporated herein by reference in their entirety.

### GOVERNMENT CONTRACT RIGHTS

The U.S. Government has a paid-up license in this invention and the right in limited circumstances to require the patent owner to license others on reasonable terms as provided for by the terms of DE-FC26-02NT41218 awarded by the U.S. Department of Energy.

### BACKGROUND

Ammonia is a singularly important compound in agriculture, where it is used as a fertilizer. Large volumes of ammonia are used to provide a nitrogen source for the gallium nitride layers in the manufacture of LEDs. Ultra-pure ammonia is important for semi-conductor applications.

There are several chemical processes that are used to manufacture ammonia. The prevalent method is the Haber-Bosch process. The Haber-Bosch process reacts gaseous hydrogen (H₂) and nitrogen (N₂) over a metal catalyst at high temperatures (e.g., at 475° C.) and pressures (e.g., at 20 MPa). The catalyst is typically an iron catalyst and includes aluminum oxide and potassium oxide as promoters. Another method for ammonia production is electrochemical dissociation. The electrochemical dissociation process also reacts hydrogen and nitrogen. However, it is an indirect synthesis via a molten alkali-metal halide electrolyte with nitrogen introduced at the cathode and hydrogen introduced at the anode. The electrochemical dissociation process also operates at elevated temperatures (e.g., at 400° C.) but at ambient pressure. Both processes require large amounts of hydrogen, which requires careful handling to minimize risk.

Nitrogen oxides are present in many waste gas streams from chemical processes, such as fertilizer production, nitration of organic compounds, nitric oxide production and the like. From an ecological and economic perspective, it is beneficial to transform a waste pollutant into a valuable product. Therefore, the conversion of undesirable nitrogen oxides into valuable ammonia is desirable.

Reduction of nitrogen oxides (NOx) emissions in exhaust gas from diesel and gasoline engines is a primary concern for meeting environmental regulations. Selective catalytic reduction (SCR) provides a method for removing nitrogen oxides (NOx) emissions from fossil fuel powered systems for engines, factories, and power plants. In short, NOₓ and a reductant are reacted over a catalyst to convert the nitrogen oxides to nitrogen gas. One embodiment of SCR uses ammonia (NH₃) as a reductant. NH₃ or ammonia precursors, such as urea, can be used to treat gaseous waste streams containing nitrogen oxides. Hydrocarbons also can be used as a SCR reductant. In the on-going pursuit of catalysts useful for selective reduction of NOₓ to nitrogen and carbon dioxide, the use of silver catalysts for SCR using hydrocarbon reductants has been tested (Miyadera et al., 1993, Trans Mat Res Soc Jpn. 18A:405-408; Kass et al., 2003, “Selective Catalytic Reduction of Diesel Engine NOx Emissions Using Ethanol as a Reductant”, US Dept. of Energy, 9^{th} Diesel Engine Emissions Reduction Conference, Newport, R.I., Aug. 23-28, 2003; Shimizu et al., 2006, Phys Chem Chem. Phys. 8:2677-2695; U.S. Pat. No. 6,284,211; US Pat. Publication No. 2007/0031310). Undesirable by-products of this reaction, including ammonia, acetaldehyde and cyanide, have been detected (Miyadera et al., 1993, ibid; Kass et al., 2003, ibid; Shimizu et al., 2006, ibid). A catalytic bed of silver on gamma-alumina followed by a catalytic bed of Ba Y zeolite has been reported to produce about 23% ammonia (US Pat. Publication No. 2007/0031310). A catalyst comprising silver aluminate supported by gamma-alumina has been reported to produce up to about 20% ammonia (U.S. Pat. No. 6,045,765).

There is a need in the art for alternative methods of producing ammonia. The methods disclosed address that need.

### SUMMARY

Provided is a method for producing ammonia from a feed stream comprising nitrogen oxide (NOx). The method comprises contacting a feed stream comprising nitrogen oxide with a catalyst in the presence of a hydrocarbon, thereby reducing the nitrogen oxide to ammonia, wherein the catalyst comprises silver dispersed on alumina particles and wherein the hydrocarbon is selected from the group consisting of one or more oxygenated hydrocarbons, one or more non-oxygenated hydrocarbons and mixtures thereof. In some embodiments, the hydrocarbon comprises one or more oxygenated hydrocarbons. In other embodiments, the hydrocarbon consists essentially of one or more oxygenated hydrocarbons. The hydrocarbon can consist essentially of ethanol.

In other embodiments, the hydrocarbon is a mixture of one or more oxygenated hydrocarbons and one or more non-oxygenated hydrocarbons. The non-oxygenated hydrocarbon can be selected from the group consisting of n-dodecane, iso-octane, 1-octene, n-octane, m-xylene and mixtures thereof. Exemplary non-oxygenated hydrocarbons include gasoline and diesel. An exemplary oxygenated hydrocarbon is ethanol.

In some embodiments, the one or more oxygenated hydrocarbons are selected from the group consisting of C1 to C4 alcohols and C2 diols. In one embodiment, the oxygenated hydrocarbon is ethanol.

The method can be practiced with a catalyst wherein the silver has a diameter of less than about 20 nm. In some embodiments, the catalyst is prepared using hydroxylated alumina. In some embodiments, the catalyst comprises silver dispersed on alumina particles, wherein the alumina comprises gamma alumina. In some embodiments, calcination of the silver dispersed on the hydroxylated alumina yields silver dispersed on gamma alumina. The hydroxylated alumina can be selected from the group consisting of: boehmite, pseudoboehmite, gelatinous boehmite, diaspore, nordstrandite, bayerite, gibbsite, alumina having hydroxyl groups added to the surface, and mixtures thereof. In an embodiment, the hydroxylated alumina is pseudoboehmite. Optionally, the pseudoboehmite is in the form of plate-shaped particles.

In some embodiments, the catalyst is substantially free of silver metal and/or substantially free of silver aluminate. In some embodiments, the catalyst comprises about 2 wt % to about 4 wt % silver on a Ag₂O basis.

In certain embodiments of the method, at least about 25% of nitrogen oxide is reduced to ammonia. In certain embodiments, the contacting step occurs at a temperature from about 200 degrees centigrade to about 500 degrees centigrade (° C.). In some embodiments, the ratio of oxygenated hydrocarbon to nitrogen oxide (HC₁:NOₓ) is at least about 2.2. In other embodiments, the ratio of oxygenated hydrocarbon to nitrogen oxide (HC₁:NOₓ) is at least about 4.3.

In some embodiments, contacting the catalyst occurs with a space velocity from about 12,750 h⁻¹ to about 51,000 h⁻¹. In some embodiments, the feed stream further comprises oxygen, carbon dioxide, and water, and optionally, carbon monoxide and hydrogen.

### BRIEF DESCRIPTION OF THE DRAWINGS

There are depicted in the drawings certain embodiments. However, the methods are not limited to the precise arrangements and instrumentalities of the embodiments depicted in the drawings.

FIG. 1 depicts a graph showing NOx conversion at different temperatures and different loading of silver catalyst using 100% ethanol as the hydrocarbon reductant. “Wt %” refers to wt % on a Ag₂O basis, of the catalysts tested.

FIG. 2 depicts a graph showing the production of ammonia (NH₃) at different temperatures and different loading of silver catalyst using 100% ethanol as the hydrocarbon reductant.

FIG. 3 depicts a graph showing the production of cyanide (HCN) at different temperatures and different loading of silver catalyst using 100% ethanol as the hydrocarbon reductant.

FIG. 4 depicts a graph showing the acetaldehyde (CH₃CHO) production at different temperatures and different loading of silver catalyst using 100% ethanol as the hydrocarbon reductant.

FIG. 5 depicts a graph showing the extent of ethanol conversion at two different loadings of silver catalyst, different gas streams and different space velocities. The closed symbols are for a low NO, high O₂ gas stream, at a low space velocity. The open symbols are for a high NO, low O₂ gas stream, at a high space velocity.

FIG. 6 depicts a graph showing the NH₃ and NOₓ presence at different ratios of hydrocarbon to NO(HC₁:NOx).

FIG. 7 depicts a graph showing NOx conversion and NH₃ production in the presence (solid and open circles) or absence (solid and open diamonds) of carbon monoxide (CO) and hydrogen (H₂) in the gas stream, as a function of catalyst temperature. The solid symbols are NOx conversion data (left hand y-axis). The open symbols are NH₃ production data (right hand y-axis).

FIG. 8 depicts a graph showing NOₓ conversion in a gas stream comprising NH₃ (NH₃:NOₓ˜1.0) and in the presence (squares) or absence (diamonds) of carbon monoxide (CO) and hydrogen (H₂), as a function of catalyst temperature.

FIG. 9 depicts a graph showing NOx conversion and NH₃ production at three different space velocities. Triangles=12,750 h⁻¹. Circles=25,500 h⁻¹. Diamonds=51,000 h⁻¹.

FIG. 10 depicts a graph showing NOx conversion at different temperatures and using different mixtures of ethanol and simulated gasoline as the hydrocarbon reductant. The catalyst was 3 wt % on a Ag₂O basis.

FIG. 11 depicts a graph showing the production of ammonia (NH₃) at different temperatures and using different mixtures of ethanol and simulated gasoline.

FIG. 12 depicts a graph showing the production of cyanide (HCN) at different temperatures and using different mixtures of ethanol and simulated gasoline.

FIG. 13 depicts a graph showing the acetaldehyde (CH₃CHO) production at different temperatures and using different mixtures of ethanol and simulated gasoline.

FIG. 14 depicts a graph showing NOx conversion at different temperatures and different loading of silver catalyst using simulated diesel as the hydrocarbon reductant. “Wt %” refers to wt % on a Ag₂O basis, of the catalysts tested.

FIG. 15 depicts a graph showing the production of ammonia (NH₃) at different temperatures and different loading of silver catalyst.

FIG. 16 depicts a graph showing the production of cyanide (HCN) at different temperatures and different loading of silver catalyst.

FIG. 17 depicts a graph showing the acetaldehyde (CH₃CHO) production at different temperatures and different loading of silver catalyst.

### DETAILED DESCRIPTION

It has been discovered that a catalyst of silver supported on alumina, prepared from a hydroxylated alumina, such as pseudoboehmite, unexpectedly has a high selectivity for production of ammonia by the reduction of nitrogen oxides in the presence of a hydrocarbon, and particularly an oxygenated hydrocarbon. Accordingly, a method of producing ammonia from a feed stream comprising nitrogen oxides is provided. The method can be used as a stand-alone practice to produce ammonia or can be used in combination with any method that requires ammonia as a reactant or yields nitrogen oxide as a product. For instance, the method described herein could be used subsequent to a method that yields nitrogen oxide, in order to reduce the nitrogen oxide level, while producing ammonia.

### DEFINITIONS

Unless defined otherwise, all technical and scientific terms used herein generally have the same meaning as commonly understood by one of ordinary skill in the art. Generally, the nomenclature used herein are those well known and commonly employed in the art.

It is understood that any and all whole or partial integers between any ranges set forth herein are included herein.

As used herein, each of the following terms has the meaning associated with it in this section.

The articles “a” and “an” are used herein to refer to one or to more than one (i.e., to at least one) of the grammatical object of the article.

The term “about” will be understood by persons of ordinary skill in the art and will vary to some extent on the context in which it is used. Generally, about encompasses a range of values that are plus/minus 10% of a reference value. For instance, “about 25%” encompasses values from 22.5% to 27.5%.

As used herein with reference to the selectivity of a catalyst, the term “selectivity” means the mole percent (%) of the desired product formed (e.g., ammonia) relative to the total of nitrogen oxide converted. A catalyst can have high conversion and low selectivity. For instance, a catalyst can have greater than 80% of the input converted to products, while less than 5% of the product is the desired product. A catalyst can also have low conversion and high selectivity. For instance, less than 50% of the input is converted, while substantially all of the input converted is the desired product (˜100% selectivity). Ideally, a catalyst has both high conversion and high selectivity. Yield of a given product equals conversion times selectivity for that product. Thus, when conversion is 100%, yield equals selectivity.

As used herein, “nitrogen oxides” refers to one or more of NO, NO₂ and N₂O.

As used herein, the term “hydroxylated” means that the surface of the alumina has a high concentration of surface hydroxyl groups in the alumina as it is obtained. Examples include boehmite, pseudoboehmite or gelatinous boehmite, diaspore, nordstrandite, bayeritc, gibbsite, alumina having hydroxyl groups added to the surface, and mixtures thereof.

As used herein, “inlet” refers to the site where the feed stream enters the catalyst, while “outlet” refers to the site where the reacted feed stream exits the catalyst.

As used herein, “upstream” refers to the inlet side or direction of the catalyst. “Downstream” refers to the outlet side or direction of the catalyst.

### DESCRIPTION

In accordance with some embodiments, provided is a process for manufacturing ammonia by contacting a silver-alumina catalyst, under suitable nitrogen oxide reduction process conditions, with a gaseous feed stream that comprises nitrogen oxide and a hydrocarbon as reductant. The catalytic material comprises silver ions dispersed on alumina as the catalytic component. In a one embodiment, the alumina used to prepare the catalytic material can be pseudoboehmite. In some embodiments, the hydrocarbon can be an oxygenated hydrocarbon, such as ethanol.

Two thermodynamically-favored reactions believed to be relevant to the method of producing ammonia from a feed stream comprising nitrogen oxide and oxygenated hydrocarbon, such as ethanol, are:

C₂H₅OH+NO+NO₂=2NH₃+2CO₂ (1)

C₂H₅OH+2NO+0.5O₂=2NH₃+2CO₂ (2)

Reaction 1 produces ammonia from NOₓ. Reaction 2 is similar to reaction 1, except that NO₂ has been replaced by an equivalent amount of NO and oxygen.

The method comprises contacting a feed stream comprising nitrogen oxide with a catalyst in the presence of a hydrocarbon. An exemplary composition of a feed stream useful in practicing the method can be that obtained from the combustion of diesel or gasoline. Accordingly, the feed stream useful in the method can comprise oxygen, water, carbon monoxide, carbon dioxide, hydrocarbons and hydrogen in amounts substantially similar to that present in a diesel or gasoline exhaust stream, in addition to nitrogen oxide and a hydrocarbon reductant. These other components (oxygen, water, carbon monoxide, carbon dioxide, hydrocarbons and hydrogen), however, are optional. Where the feed stream comprises oxygen, the nitrogen oxide need not include NO₂, in the practice of the claimed method (see Eq. 2). Where the feed stream comprises low or no oxygen, NO₂ is needed in the feed stream (see Eq. 1). In another embodiment, the method can be practiced with a feed stream that is produced by diesel or gasoline combustion. In exemplary embodiments, components that can poison the catalyst, including, but not limited to, phosphorus, sulfur and the like, should be minimized or avoided altogether.

In practicing the method, a feed stream comprising nitrogen oxide with a catalyst in the presence of a hydrocarbon. The hydrocarbon can be substantially a single hydrocarbon or can be a mixture of two or more hydrocarbons. Hydrocarbons useful in the method comprise non-oxygenated and oxygenated hydrocarbons, and mixtures thereof. Mixtures can be mixtures of two or more oxygenated hydrocarbons, mixtures of two or more non-oxygenated hydrocarbons, and mixtures of one or more oxygenated hydrocarbons and one or more non-oxygenated hydrocarbons. Exemplary hydrocarbons include saturated, olefinic and aromatic hydrocarbons, including branched and linear hydrocarbons and olefins, as well as substituted aromatics and mixtures thereof. Examples include dodecane, xylene, isooctane, 1-octene, n-octane and mixtures, such as a mixture of dodecane and xylene and fuels such as gasoline and diesel fuel. Oxygenated hydrocarbons useful in the methods are C1 to C8 compounds containing one or more oxygenated functional groups, such as hydroxyl (—OH), aldehyde, ketone, ester, lactone or acid groups. In some embodiments, an oxygenated hydrocarbon can be selected from the group consisting of C1 to C4 alcohols and C2 diols. Examples include, but not limited to, methanol, ethanol, propanol, isopropanol, butanol, 1,3 propanediol, 1,4 propanediol, ethylene glycol, acetaldehyde, propanal, acetic acid, 1-hydroxy propanal, acetone, and mixtures thereof. In yet another embodiment, the oxygenated hydrocarbon is ethanol. Mixtures including oxygenated hydrocarbons are also useful, such as a mixture of ethanol, isooctane, 1-octene, n-octane and m-xylene or a mixture of ethanol and a fuel, such as gasoline or diesel. In particular, a mixture of oxygenated hydrocarbon and non-oxygenated hydrocarbon comprising at least about 50 vol. % oxygenated hydrocarbon can be useful. In one embodiment, a mixture comprising at least about 50 vol. % ethanol mixed with gasoline can be used. The oxygenated hydrocarbon can be present in the feed stream, such as a feed stream produced by combustion of diesel or gasoline containing fuel additives, or can be introduced into the feed stream prior to or substantially concurrent with the feed stream contacting the silver catalyst. In practicing the method, the ratio of oxygenated hydrocarbon to nitrogen oxide (HC₁:NOₓ) is at least about 2.2, at least about 4.3 or about 8.6.

The catalyst used in the method comprises as the catalytic component silver dispersed on alumina particles; in an exemplary embodiment, the silver has a diameter of less than about 20 nm. The silver catalyst enables a high conversion of input nitrogen oxides. In exemplary embodiments, the catalyst converts at least about 60%, at least about 80% or at least about 90% of nitrogen oxide. Furthermore, the catalyst is shown herein to have a high selectivity for producing ammonia from nitrogen oxides. Consequently, the silver catalyst has a high yield of ammonia. Silver supported on alumina, wherein the silver is deposited on a hydroxylated alumina to prepare the catalyst, catalyzes at least about 25%, at least about 30%, at least about 37%, or at least about 40% of input nitrogen oxide to ammonia in the method. Such high yield has not been disclosed for alumina-supported silver catalysts in the prior art. Advantageously, a high conversion rate of input nitrogen oxide can be achieved and the production of undesirable by-products, such as acetaldehyde and cyanide, by the alumina-supported silver catalyst can be minimized (thereby increasing selectivity for ammonia), by judicious selection of reaction conditions, for instance, temperature and choice of reductant. Yields in excess of at least about 50%, 60%, 70%, 80% or 90% are therefore also contemplated. In exemplary embodiments, the catalyst temperature can be from about 200 degrees centigrade (° C.) to about 550° C., from about 300° C. to about 500° C., or from about 350° C. to about 450° C.

In some embodiments, the catalytic component of the catalyst excludes other precious metals, such as platinum, palladium, rhodium, iridium and gold, and/or non-precious metals, such as base metals. In some embodiments, the catalytic component consists essentially of silver.

In some embodiments, the method can be practiced at about 300° C. with a catalyst consisting essentially of 3 wt % silver (on a Ag₂O basis) supported on alumina, the catalyst being prepared using pseudoboehmite, is employed, where at least about 90% or about 100% of input nitrogen oxide is converted and the selectivity is at least about 25%. In other embodiments, the method can be practiced from about 350° C. to about 450° C., with a catalyst consisting essentially of 3 wt % silver (on a Ag₂O basis) supported on alumina, the catalyst being prepared using pseudoboehmite, is employed, where about 100% of input nitrogen oxide is converted, the selectivity is at least about 37%, essentially no acetaldehyde or cyanide is produced. In these exemplary embodiments, the hydrocarbon comprises an oxygenated hydrocarbon such as at least about 85% ethanol and the HC₁:NOₓ is about 8.6.

In the practice of the method, the space velocity of the reaction can be selected to adjust the production of ammonia under the given reaction conditions. In some uses, maximizing ammonia production is desired. In some uses, however, such as conversion of NOₓ all the way to nitrogen, it can be useful to not maximize ammonia production, but only to produce enough to react further with NOₓ, i.e., about 50% yield of ammonia.

For high yields of ammonia, it is desirable to minimize the contact time of the feed gas stream with the catalyst to avoid competing reactions, such as hydrocarbon SCR where the hydrocarbon is an oxygenated hydrocarbon, such as ethanol and the like. The contact time can be reduced by increasing the space velocity and thus reducing competing reactions. However, if one wants to convert the NOₓ to nitrogen, one would want to increase contact time or decrease space velocity. Alternatively, one could react the ammonia produced by the subject catalyst with remaining NO over a subsequent second catalyst (for instance, an NH₃ SCR catalyst) that is designed to react ammonia with NOₓ to produce nitrogen.

An exemplary silver-alumina catalyst comprises about 1 to 5 weight percent (wt %) silver, about 2 to 4 wt. %, or about 3 wt %, on an Ag₂O basis, supported on alumina. Note that the silver in the catalyst is not in the form of Ag₂O; the weight percent is indicated on an Ag₂O basis because it is common practice in elemental analysis data of elements in an oxide matrix to be reported as metal oxides. The weight percent on an Ag₂O basis can be readily converted to weight percent silver by multiplying by the ratio of the atomic weight of silver and the molecular weight of Ag₂O. For instance, 3 wt % silver on a Ag₂O basis is equal to about 2.72 wt % silver. The catalyst can be prepared by depositing ionic silver on a refractory support material such as alumina. In an exemplary embodiment, the catalyst used in the method can be prepared by depositing ionic silver on highly hydroxylated alumina. Exemplary hydroxylated alumina include boehmite, pseudoboehmite or gelatinous boehmite, diaspore, nordstrandite, bayerite, gibbsite, alumina having hydroxyl groups added to the surface, and mixtures thereof. Pseudoboehmite and gelatinous boehmite are generally classified as non-crystalline or gelatinous materials, whereas diaspore, nordstrandite, bayerite, gibbsite, and boehmite are generally classified as crystalline. According to one or more embodiments, the hydroxylated alumina used for preparing a catalyst for producing ammonia can be represented by the formula Al(OH)ₓO_{y} where x=3-2y and y=0 to 1 or fractions thereof. In the preparation of such hydroxylated aluminas, the alumina is not subject to high temperature calcination, which would drive off many or most of the surface hydroxyl groups.

Substantially non-crystalline hydroxylated aluminas in the form of flat, plate-shaped particles, as opposed to needle-shaped particles, are useful in preparing catalysts. In embodiments, the hydroxylated alumina excludes needle-shaped particles, such as needle-shaped boehmite particles. The shape of the hydroxylated alumina useful for preparing the catalyst used in the claimed method can be in the form of a flat plate and has an average aspect ratio of 3 to 100 and a slenderness ratio of a flat plate surface of 0.3 to 1.0. The aspect ratio is expressed by a ratio of “diameter” to “thickness” of a particle. The term “diameter” as used herein means a diameter of a circle having an area equal to a projected area of the particle, which is obtained by observing the alumina hydrate through a microscope or a Transmission Electron Microscope (TEM). The slenderness ratio means a ratio of a minimum diameter to a maximum diameter of the flat plate surface when observed in the same manner as in the aspect ratio.

Hydroxylated, flat, plate-shaped particulate aluminas which can be used in producing the catalysts according to embodiments are known and are commercially available. Processes for producing them are also known. Exemplary processes for producing pseudoboehmite are described in, for example. U.S. Pat. No. 5,880,196 and International Publication No. WO 97/22476.

Pseudoboehmite has a boehmite-like structure. The X-ray diffraction pattern, however, consists of very diffuse bands or halos. The spacings of the broad reflections correspond approximately with the spacings of the principal lines of the pattern of crystalline boehmite, but the first reflection, in particular, commonly shows appreciable displacements to values as large as 0.66 to 0.67 nanometer compared with the 0.611 nanometer reflection for the 020 line for boehmite. It has been suggested that although the structure resembles that of boehmite in certain respects, the order can be only of very short range. It is generally accepted by those skilled in the art that pseudoboehmite is a distinct phase which is different from boehmite. See Encyclopedia of Chemical Technology, 5^{th} Ed., Vol. 2, Wiley Inter science, 2004, pages 421-433, and “Oxides and Hydroxides of Aluminum,” Alcoa Technical Paper No. 19, Revised, by Karl Wefers and Chanakya Misra, 1987, Copyright Aluminum Company of America.

Alternatively, a calcined alumina can be treated in a manner to add surface hydroxyl groups, for example, by exposing the alumina to steam for a period of time. In one or more embodiments, the alumina used for silver impregnation can be substantially free of gamma alumina. Upon calcination, the hydroxylated alumina used during the preparation can transform to, for example, gamma alumina. Thus, the final catalyst after silver impregnation, drying, calcination, and/or hydrothermal treatment, can comprise gamma alumina and/or other high temperature alumina phases.

In one or more embodiments, the silver supported on alumina can be substantially free of silver metal and/or silver aluminate. As used herein, substantially free means that there is less than 0.1% by weight of silver metal or silver aluminate. As used herein, “silver metal” means silver in the zero oxidation state, which means that the silver atom is neither positively nor negatively charged. The zero oxidation state is typically the oxidation state for aggregates of uncharged silver atoms or silver metal contrasted with positively charged silver, which is called “ionized silver” or “ionic silver.” An ionic silver atom has a positive charge (+1) and is said to have a+1 oxidation state. Since elemental silver has a single electron in its outermost electron shell, Ag (I) or Ag⁺¹ is by far the most common oxidation state for ionic silver. If the silver atom accepts an electron from a more electropositive material it would then become negatively charged and said to have a “−1” oxidation state, or alternatively be a negative ion or anion.

Silver catalysts useful in practicing the method have ionic silver well-dispersed on the surface of the alumina. A small particle size indicates high dispersion on the surface of the alumina. According to one or more embodiments, the supported silver has an average particle size of less than about 20 nm, less than about 10 nm or less than about 2 nm. Transmission Electron Microscope (TEM) analysis of catalysts can be used to assess the size of ionic silver.

As noted above, suitable aluminas for preparation of the catalytic material include boehmite or pseudo boehmite/gelatinous alumina with surface area of at least about 20 m²/g. According to one or more embodiments, the hydroxylated alumina used for preparation of the catalytic material can be substantially free of gamma alumina. The silver can be deposited on the alumina support by any method known in the art, including wet impregnation and incipient wetness impregnation. “Incipient wetness” is known in the art to mean a volume of solution equal to the pore volume of the support. In the wet impregnation process, the support is immersed in an excess amount of silver-containing solution, followed by evaporation of the excess liquid. A single impregnation or a series of impregnations, with or without intermediate drying, can be used, depending in part upon the concentration of the silver salt in the solution. The deposition of silver can also be achieved by other techniques, such as chemical vapor deposition.

The hydroxylated alumina can be impregnated with a water soluble, ionic form of silver such as silver acetate, silver nitrate, etc., and followed by drying and calcining the ionic silver-impregnated alumina at a temperature low enough to fix the silver and decompose the anion (if possible). Typically, for the nitrate salt, this calcination temperature would be about 450-550° C. to provide an alumina that has substantially no silver particles greater than about 20 nm in diameter. In certain embodiments, the diameter of the silver can be less than 10 nm, and in other embodiments, the silver can be less than about 2 nm in diameter.

In one or more embodiments, the processing can be performed so that the silver is present in substantially ionic form, and there is substantially no silver metal present, as determined by UV spectroscopy. In one or more embodiments, there can be substantially no silver aluminate present. The absence of silver metal and silver aluminatc can be also confirmed by x-ray diffraction analysis. Following the calcination step, the catalyst can optionally subjected to a hydrothermal treatment in 10% steam in air. The hydrothermal treatment can be carried out at temperatures ranging from about 400° C. to 700° C., or at about 650° C., for 1 to 48 hours.

It can also be desired to modify the hydroxylated alumina prior to impregnation with silver. This can be accomplished utilizing a variety of chemical reagents and/or processing treatments such as heat or steam treatments to modify the alumina surface properties and/or physical properties. This modification of the alumina properties can improve the performance properties of the catalyst for properties such as activity, stability, silver dispersion, sintering resistance, resistance to sulfur and other poisoning, etc. However, the processing should be performed so that chemical modification of the alumina surface does not substantially negatively impact the silver-alumina interaction.

The alumina-supported silver catalyst is typically dispersed on a substrate. The substrate cab be any of those materials typically used for preparing catalysts, and can comprise a ceramic or metal honeycomb structure or pellets. Any suitable substrate can be employed, such as a monolithic substrate of the type having fine, parallel gas flow passages extending therethrough from an inlet or an outlet face of the substrate, such that passages are open to fluid flow therethrough (referred to as honeycomb flow through substrates). The passages, which are essentially straight paths from their fluid inlet to their fluid outlet, are defined by walls on which the catalytic material can be coated as a washcoat so that the gases flowing through the passages contact the catalytic material. The flow passages of the monolithic substrate are thin-walled channels, which can be of any suitable cross-sectional shape and size such as trapezoidal, rectangular, square, sinusoidal, hexagonal, oval, circular, etc. Such structures can contain from about 60 to about 600 or more gas inlet openings (i.e., cells) per square inch of cross section. Monoliths are commonly used in automobile aftertreatment (gasoline and diesel). Monoliths are also used in other chemical processes to reduce reaction backpressure and increase flow rate (space velocity). Alternatively, the subject catalyst could be in the form of spheres, extrudates, trilobes and other forms common in the chemical and catalyst industries and used, for instance, in a packed bed or fluid bed configuration.

The substrate can also be a wall-flow filter substrate, where the channels are alternately blocked, allowing a gaseous stream entering the channels from one direction (inlet direction), to flow through the channel walls and exit from the channels from the other direction (outlet direction). If such substrate is utilized, the resulting system will be able to remove particulate matters along with gaseous pollutants. The wall-flow filter substrate can be made from materials commonly known in the art, such as cordierite or silicon carbide.

A ceramic substrate can be made of any suitable refractory material, e.g., cordierite, cordierite-alumina, silicon nitride, zircon mullite, spodumene, alumina-silica magnesia, zircon silicate, sillimanite, a magnesium silicate, zircon, petalite, alumina, an aluminosilicate and the like.

The substrates useful for the catalysts can also be metallic in nature and be composed of one or more metals or metal alloys. The metallic substrates can be employed in various shapes such as corrugated sheet or monolithic form. Exemplary metallic supports include the heat resistant metals and metal alloys such as titanium and stainless steel as well as other alloys in which iron is a substantial or major component. Such alloys can contain one or more of nickel, chromium and/or aluminum, and the total amount of these metals can advantageously comprise at least 15 wt % of the alloy, e.g., 10-25 wt % of chromium, 3-8 wt % of aluminum and up to 20 wt % of nickel. The alloys can also contain small or trace amounts of one or more other metals such as manganese, copper, vanadium, titanium and the like. The surface of the metal substrates can be oxidized at high temperatures, e.g., 1000° C. and higher, to improve the resistance to corrosion of the alloys by forming an oxide layer on the surfaces of the substrates. Such high temperature-induced oxidation can enhance the adherence of the refractory metal oxide support and catalytically promoting metal components to the substrate.

In alternative embodiments, one or more catalyst compositions can be deposited on an open cell foam substrate. Such substrates are well known in the art, and are typically formed of refractory ceramic or metallic materials.

According to one or more embodiments, when deposited on the honeycomb monolith substrates, such silver on alumina catalyst compositions are deposited on a substrate at a concentration of at least 1 g/in³ to ensure that the desired ammonia production is achieved and to secure adequate durability of the catalyst over extended use. In one embodiment, there can be at least 1.6 g/in³ of catalyst, and in particular, there can be at least 1.6 to 5.0 g/in³ of the catalyst disposed on the monolith. Catalyst loading on monoliths, or any other substrate, can readily be adjusted by the skilled artisan without undue experimentation.

Catalyst can be deposited on a substrate using any method known in the art. A typical method can be washcoating. A single layer of catalyst can be deposited on a substrate, or two or more layers can be deposited. A representative process for preparing a bi-layer washcoat is described. For a bi-layer washcoat, the bottom layer, finely divided particles of a high surface area refractory metal oxide such as gamma alumina are slurried in an appropriate vehicle, e.g., water. The substrate can then be dipped one or more times in such slurry or the slurry can be coated on the substrate (e.g., honeycomb flow through substrate) such that there will be deposited on the substrate the desired loading of the metal oxide. In some embodiments, components such precious metals or platinum group metals, transition metal oxides, stabilizers, promoters and an NOₓ sorbent material can be incorporated in the slurry as a mixture of water soluble or water-dispersible compounds or complexes. In another embodiment, the slurry contains only the alumina-supported silver catalyst material in the vehicle. Thereafter, the coated substrate is typically calcined by heating, e.g., at 400 to 600° C. for 1 to 3 hours.

In one or more embodiments, the slurry can be comminuted to result in substantially all of the solids having particle sizes of less than 20 microns, e.g., 1-15 microns, in an average diameter. The comminution can be conducted in a ball mill or other similar equipment, and the solids content of the slurry can be, e.g., 20-60 wt. %, or 35-45 wt. %.

Any reactor known in the art that is suitable for practicing reduction of nitrogen oxide in a feed stream can be used. Such reactors include, but are not limited to, packed bed, fixed bed, fluidized bed and ebullated bed. Chemical reactor technology is well known to the skilled artisan. See, for instance, Nauman, 2002, Chemical Reactor Design, Optimization, and Scaleup, McGraw-Hill and Levenspiel, 1998, Chemical Reaction Engineering, 3^{rd} edition, Wiley. In one embodiment, the method can be practiced with the silver catalyst in a packed bed reactor (PBR). In a PBR, ideally, all of the feed stream flows at the same velocity, parallel to the reactor axis with no back-mixing. All material present at any given reactor cross-section has had an identical residence time. The longitudinal position within the PBR is, therefore, proportional to the time spent within the reactor; all product emerging with the same residence time and all substrate molecule having an equal opportunity for reaction.

In some embodiments, an optional filter can be used upstream of the catalytic bed of the reactor to reduce or eliminate particulates that might occlude the catalytic bed. Such filters are optionally catalyzed to aid in the removal of collected particulates, for instance, by combustion.

In an exemplary embodiment, ammonia is produced when an nitrogen oxide containing gas is contacted with an oxygenated hydrocarbon, which comprises ethanol in exemplary embodiments, and can consist of about 100% ethanol, in the presence of a silver-alumina catalyst under suitable nitrogen oxide reduction conditions. In exemplary embodiments, the catalyst can be loaded with 3 wt % on the basis of Ag₂O, with a silver particle size of less than 20 nm or about 1-2 nm. The catalyst can be substantially free of silver aluminate and/or silver metal. The feed stream containing nitrogen oxide can be the exhaust of diesel or engine combustion, or a feed stream having a composition substantially the same as combustion exhaust. The process can be carried out at from about 250° C. to about 600° C. In exemplary exbodiments, the process can be carried out at a temperature in the range of from about 300° C. to about 550° C., or about 350° C. to about 500° C. The ratio of ethanol to nitrogen oxide (HC₁:NOₓ) can be at least about 2.0, at least about 4.6, or about 8.6.

The ammonia produced by the method can be purified and recovered from the reaction mixture employing methods known in the art. See for instance, U.S. Pat. Nos. 5,496,778; 5,846,386; 6,749,819; and 7,001,490, and WO 2002/051752. Ammonia gas can be liquified using methods known in the art, for instance, rotary compression.

The ammonia produced can also be used immediately or with intervening processing in a downstream method requiring ammonia. In one embodiment, the method can be used in conjunction with an ammonia selective catalytic reduction (SCR) method. Such a combination can be used to reduce pollutants from exhaust gas of stationary diesel or gasoline engines or vehicle engines, e.g. automobiles and buses.

In order to further illustrate the method, various examples are given below. The following examples should not be construed as in any way limiting.

### EXAMPLES

Throughout these examples, as well as throughout the rest of this specification and claims, all parts and percentages are by weight and all temperatures are in degrees Centigrade unless indicated otherwise.

The catalysts were prepared by standard incipient wetness impregnation techniques using the following procedure. A 1 M solution of silver nitrate was prepared using deionized (DI) water. The resulting solution was stored in a dark bottle away from light sources. The available pore volume of the various supports was determined by titrating the bare support with water while mixing until incipient wetness was achieved. This resulted in a liquid volume per gram of support. Using the final target Ag₂O level and the available volume per gram of support, the amount of 1 M AgNO₃ solution needed was calculated. DI water was added to the silver solution, if needed, so that the total volume of liquid was equal to amount needed to impregnate the support sample to incipient wetness. If the amount of AgNO₃ solution needed exceeded the pore volume of the support, then multiple impregnations were done.

The appropriate AgNO₃ solution was added slowly to the alumina support with mixing. After incipient wetness was achieved, the resulting solid was dried at 90° C. for 16 h, then calcined at 540° C. for 2 hours. In each of the examples below, the catalyst was also optionally subjected to a flowing stream of about 10% steam in air for typically about 16 hours at 650° C.

Catalytic materials were prepared using commercially-available pseudoboehmite (Catapal® C1, 270 m²/g, 0.41 cc/g pore volume, 6.1 nm average pore diameter, produced by Sasol, North America).

For evaluation of ammonia production, the catalyst powder was washcoated onto a small cylindrical cordierite monolith (¾″ diameter×1.0″ length) of 400 cells/in³ by dip-coating the monolith into an aqueous slurry of the catalyst powder by standard techniques. The dipped monolith was then dried at 120° C. for 2 hours, then calcined at 540° C. for 2 hours. Final catalyst loading was typically 2.5-3.0 g/in³. Specific loading for each catalyst is shown in Table 1. Catalysts were compared in the examples below at similar loadings and equivalent space velocities.

TABLE 1

| Inv. Ex. | Wt % Ag₂O | Loading (g/in³) |
|---|---|---|
| A | 1 | 3.03 |
| B | 1.5 | 2.89 |
| C | 2 | 2.60 |
| D | 3 | 2.64 |
| E | 4 | 2.76 |
| F | 5 | 2.74 |

Analysis of the performance of the Inventive Examples samples was accomplished by using a tubular flow through reactor. A simulated exhaust gas feed stream was passed through a sample of the Ag—Al catalyst on 400 cell-per-square inch cordierite monolith substrate, using a hydrocarbon reductant. The reactor system was instrumented with appropriate sensors, including a Fourier transform infrared spectrometer to determine NOₓ concentration levels (and other species) entering/exiting the catalyst, and a flow meter to determine exhaust flow rate translatable to catalyst space velocity (SV).

Baseline laboratory conditions included the following standard gases in the simulated exhaust feed stream: 6% O₂, 5% CO₂, 5% H₂O, 750 parts per million (hereinafter “ppm”) CO, 250 ppm H₂, 400 ppm NO, and 1724 ppm C₂H₅OH (HC₁:NOₓ˜8.6). The reactants were passed over the catalyst bed at different temperatures (200, 250, 300, 350, 450, 500 and 550° C.). Space velocity represents a rate of feed of gas, in volume, per unit volume of the catalyst, and has a unit of inverse hour (h⁻¹). Space velocity in the examples was about 25,500 h⁻¹.

The catalysts were tested for the selective reduction of NOₓ using ethanol, ethanol/simulated gasoline mixtures or simulated diesel fuel as the hydrocarbon. Catalysts having 1, 1.5, 2, 3, 4 or 5 wt % Ag₂O were tested for conversion of NOₓ using ethanol and sim-diesel at various temperatures. For the ethanol/sim-gas mixtures, a catalyst having 3 wt %, Ag₂O was tested using 6 mixtures of ethanol and sim-gasoline (ranging from 0 vol. % ethanol to 100 vol. % ethanol).

Catalysts were also tested for production of: ammonia (NH₃), cyanide (HCN), and acetaldehyde (CH₃CHO), using ethanol, ethanol/simulated gasoline mixtures or simulated diesel fuel as the hydrocarbon and as a function of catalyst bed temperature. The compositions used for the simulated fuels were obtained from the General Motors Global Diesel Database and the General Motors Global Gasoline Database, with the fractions selected based on the maximum volumetric percentages of each hydrocarbon type (i.e., branched, saturated, unsaturated, aromatic) found in the database.

The results for the ethanol reductant experiments are presented first.

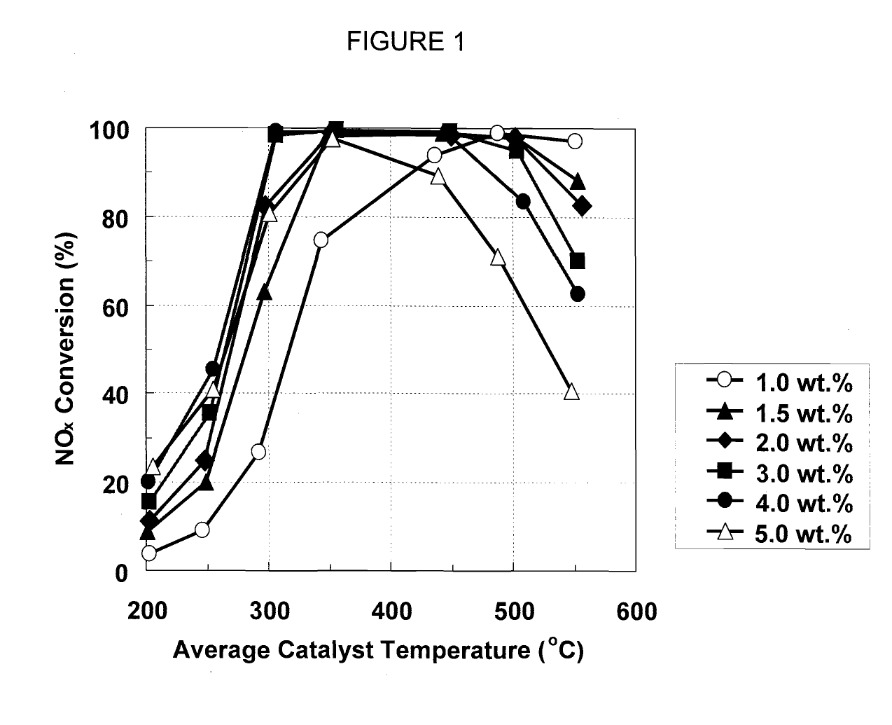

As shown in FIG. 1, all catalysts reached about 99-100% conversion when ethanol was the hydrocarbon reductant, depending on the temperature. At 300° C., catalysts having 2, 3, 4 and 5 wt. % catalyzed ≧80% conversion. Conversion percent is calculated as 100×(1−(NOₓ out/NOₓ in)). The widest temperature window for NO conversion was the 3 wt % catalyst, which showed about 96 to about 99% conversion from 300 to 500° C. The 4 wt % catalyst showed about 99-100% conversion from 300 to 450° C. The 2 wt % catalyst showed about 98-99% conversion from 350 to 500° C.

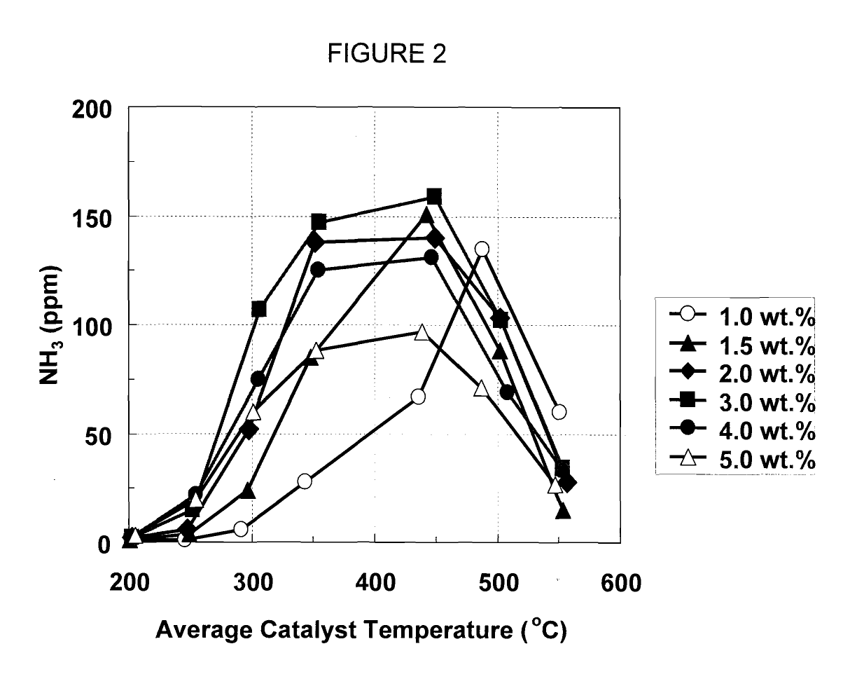

As shown in FIG. 2, all of the catalysts tested produced ammonia. The amount produced was influenced by both the wt % loading of silver on the catalyst and the temperature of the reaction. The catalysts having 2, 3, 4 or 5 wt % Ag₂O catalyzed a yield of at least about 12.5% NH₃ (50 ppm NH₃ produced of the 400 ppm NOx input) from 300° C. to 500° C., inclusive. From 350° C. to 450° C. inclusive, catalysts having 2, 3, or 4 wt % catalyzed a yield of at least about 31% NH₃. At 500° C., the 2 and 3 wt % catalysts yielded at least about 25% NH₃. The 3 wt % catalyst also produced at least about 25% at 300° C. From 350 to 450° C. inclusive, the 3 wt % catalyst produced at least about 37%. The maximum yield detected in this experiment for the 3 wt % catalyst was about 40% at 450° C. Approximate conversion, NH₃ selectivity and NH₃ yield percents under these conditions are summarized in Table 2 for the catalysts having 2, 3 and 4 wt % Ag₂O.

TABLE 2

| | 2 wt % | | | 3 wt % | | | 4 wt % | | |
|---|---|---|---|---|---|---|---|---|---|
| ° C. | C | Y | S | C | Y | S | C | Y | S |
| 300 | 82 | 13 | 15.8 | 98 | 26.7 | 27.2 | 99 | 18.8 | 19 |
| 350 | 98 | 34.5 | 35.2 | 99 | 37 | 37.4 | 100 | 31 | 31 |
| 450 | 99 | 40 | 44.4 | 99 | 40 | 40.4 | 99 | 32.5 | 32.8 |
| 500 | 98 | 25.8 | 26.3 | 96 | 25.5 | 26.6 | 84 | 16.8 | 20 |

C = conversion (in percent)
Y = yield of ammonia (in percent)
S = selectivity for ammonia (in percent; based on conversion and yield)

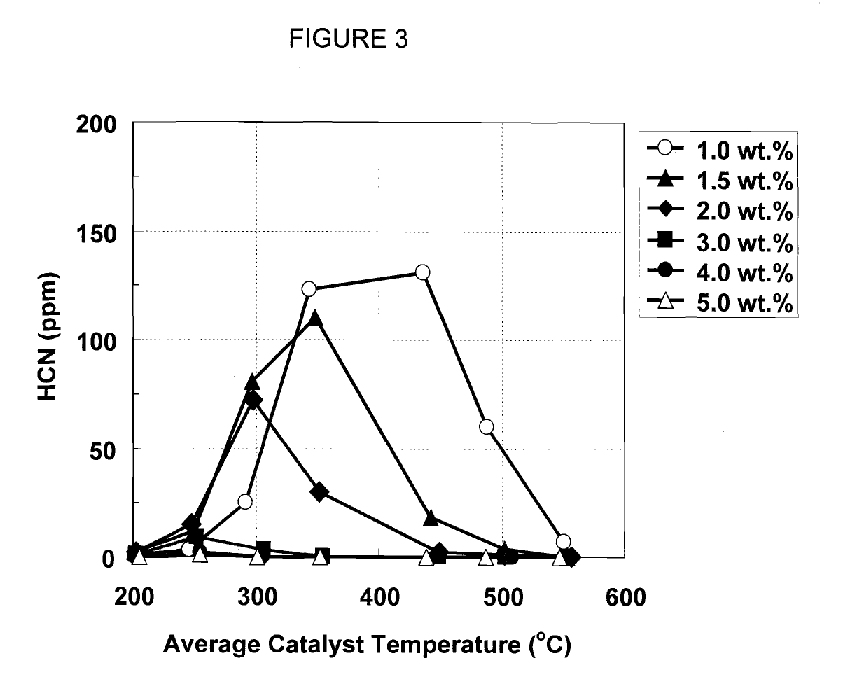

FIG. 3 shows the production of cyanide by each catalyst at different temperatures. Catalysts having 2 wt % or less Ag₂O produced cyanide, particularly from about 300 to about 500° C., inclusive. Cyanide production by the 2 wt % catalyst peaked at about 300° C. and declined to near 0% at 450° C. Advantageously, catalysts having 3, 4 or 5 wt % Ag₂O produced very low quantities of cyanide over all temperatures tested and in particular, virtually no cyanide from about 300 to 500° C., inclusive.

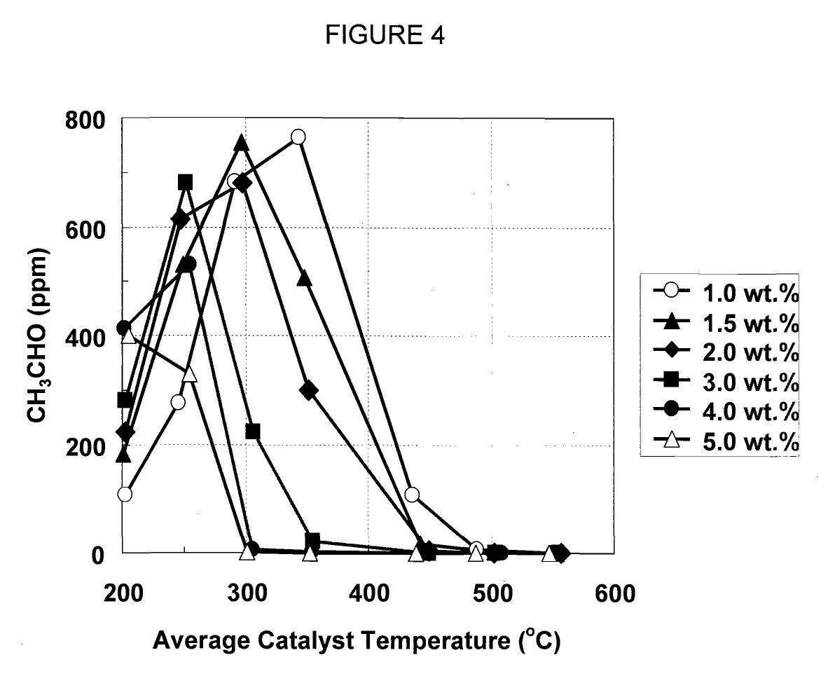

FIG. 4 shows the production of acetaldehyde by each catalyst at different temperatures. All the catalysts produced acetaldehyde, particularly at lower temperatures (350° C. and below). From 300° C. and up, the 3, 4 and 5 wt % catalysts produced low levels of acetaldehyde; from 350° C., these catalysts produced virtually no acetaldehyde.

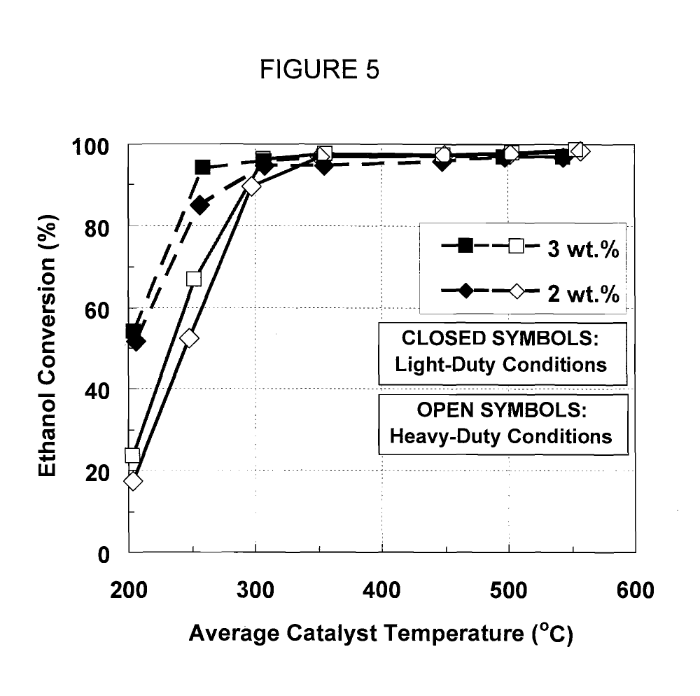

The extent of ethanol conversion by catalysts having 2 and 3 wt % Ag₂O was tested using two different exhaust feeds. One gas feed was low oxygen, high NO: 6% O₂, 5% CO₂, 5% H₂O, 750 ppm CO, 250 ppm H₂, 400 ppm NO, and 1724 ppm C₂H₅OH (HC₁:NOₓ˜8.6), and a space volume of about 25,500 h⁻. The other gas feed was high oxygen, low NO: 10% O₂, 5% CO₂, 5% H₂O, 750 ppm CO, 250 ppm H₂, 100 ppm NO, and 1724 ppm C₂H₅OH(HC₁:NOₓ˜8.6) and a space velocity of about 12,750 h⁻¹. As shown in FIG. 5, at 300° C. and above, both the 2 wt % and the 3 wt % catalysts catalyzed at least about 90% conversion of ethanol for either gas feed. For both gas feeds, the 3 wt % catalyst catalyzed about 100% conversion of ethanol at 300° C. and above.

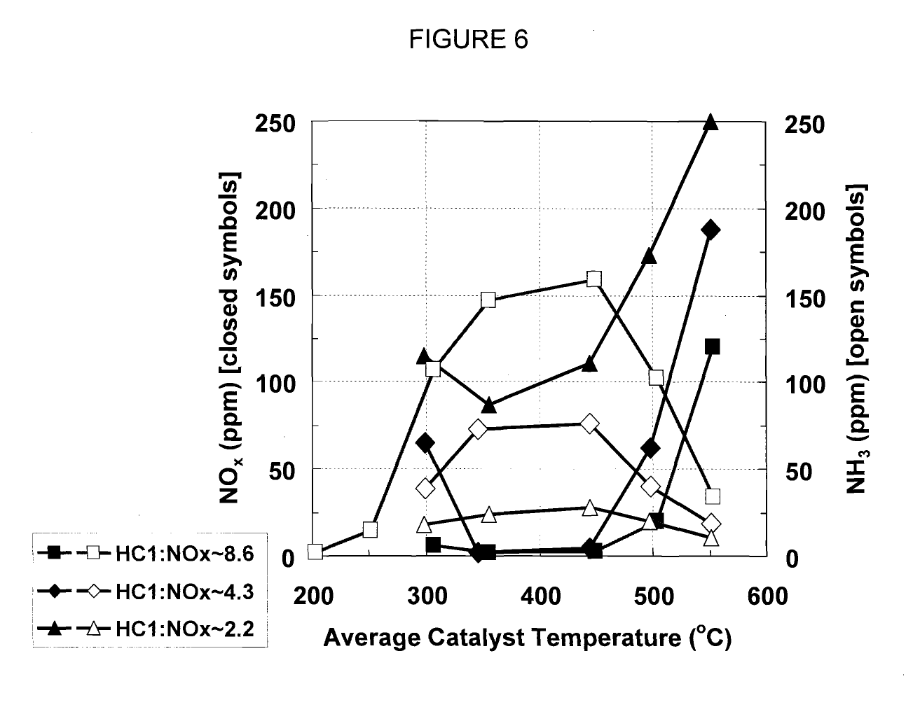

Ammonia production of the 3 wt % Ag₂O catalyst was also tested as a function of the amount of ethanol. The gas stream contained 400 ppm NO and either 431 ppm ethanol, 781 ppm ethanol or 1724 ppm ethanol. These conditions correspond to HC₁:NO ratio of about 2.2, about 4.3 and about 8.6, respectively. As shown in FIG. 6, ammonia production decreased and NOₓ breakthrough increased as the injection amount is reduced. From 350 to 450° C., at HC₁:NO about 4.3, there was minimal NO breakthrough. A broader range was observed for HC₁:NO about 8.6. From 300 to 500° C., there was minimal NO breakthrough, while there was ammonia production of at least about 25%, reaching about 40% at 450° C.

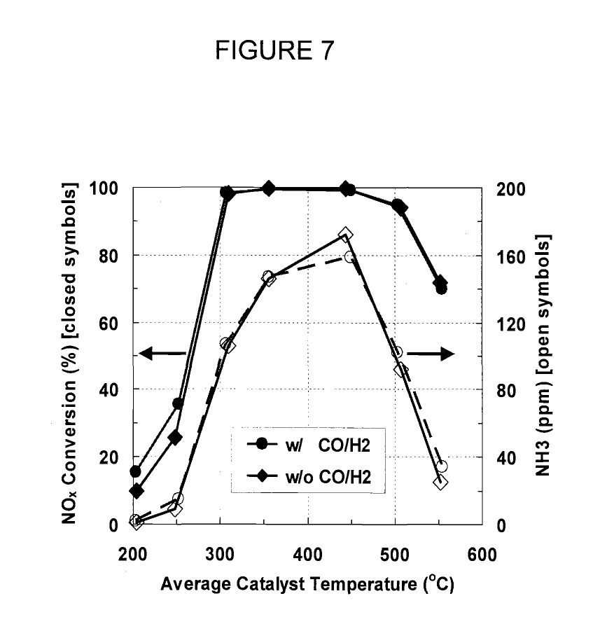

Ammonia production of the 3 wt % Ag₂O catalyst was also tested as a function of the presence or absence of carbon monoxide and hydrogen in the gas stream. This experiment was performed to determine whether the high production of ammonia is an artifact of the reaction conditions. Specifically, NH₃ is produced from NO by loss of an oxygen atom and the addition of 3 hydrogen atoms to N. One possibility for the high production of NH₃ from the silver catalyst is that reductants, such as CO and H₂, are being supplied. Two gas streams were tested in this experiment. One gas feed was: 6% O₂, 5% CO₂, 5% H₂O, 750 ppm CO, 250 ppm H₂, 400 ppm NO, and 1724 ppm C₂H₅OH (HC₁:NOₓ˜8.6), and a space velocity of about 25,500 h⁻¹ (solid and open circles in FIG. 7). The other gas feed was the same except without CO or H₂: 6% O₂, 5% CO₂, 5% H₂O, 0 ppm CO, 0 ppm H₂, 400 ppm NO, and 1724 ppm C₂H₅OH(HC₁:NOₓ˜8.6), and a space velocity volume of about 25,500 h⁻¹ (solid and open diamonds in FIG. 7). The data in FIG. 7 reveal that the production of ammonia is not substantially changed in the absence of CO and H₂. This data supports that the high NH₃ formation is not an artifact resulting from the presence of CO or hydrogen.

In a feed stream consisting of NO, O₂, H₂O, CO₂, H₂, CO and ethanol, the main nitrogen-containing products are N₂ and NH₃. It is formally possible that the N₂ product arises from a secondary ammonia SCR reaction (Equation 5), rather than from hydrocarbon SCR.

4NH₃+4NO+O₂--->4N₂+6H₂O (5)

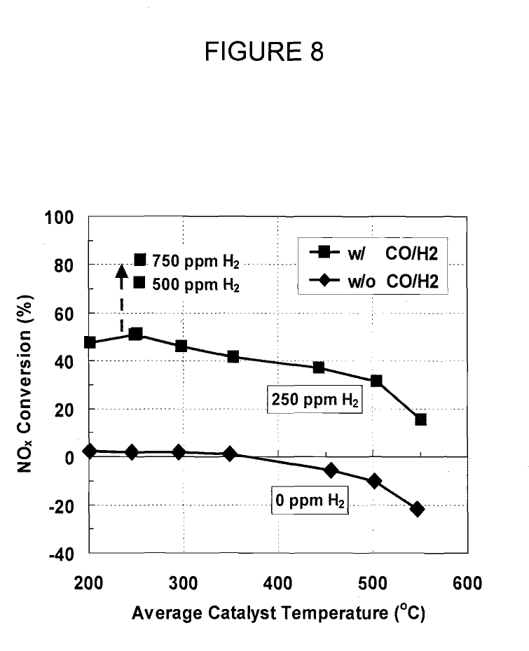

The following experiment was performed to assess whether the 3 wt % Ag₂O catalyst is functioning as an NH₃—SCR catalyst. Two gas streams were tested. One gas feed was: 6% O₂, 5% CO₂, 5% H₂O, 400 ppm NO, 400 NH₃ (NH₃:NOₓ˜1.0), 750 ppm CO and 250 ppm H₂. The second gas stream was identical to the first but without the CO and H₂. Thus, the second gas stream was 6% O₂, 5% CO₂, 5% H₂O, 400 ppm NO, and 400 NH₃ (NH₃:NOₓ˜1.0). The space velocity of about 25,500 h⁻¹. The data are shown in FIG. 8. The data show that when ammonia and NO are fed to the catalyst simultaneously (without ethanol), there is no N₂ formation in the absence of H₂/CO. When H₂ is present in increasing amounts, NOₓ conversion increases. This result suggests that the 3 wt % Ag₂O catalyst is a poor NH₃—SCR catalyst. This result also suggests that the silver catalyst is a moderately active catalyst for SCR where H₂ is the reductant, as shown in Equation 6.

2NO+2H₂-->N₂+2H₂O (6)

Furthermore, the results shown in FIG. 7 indicate NOₓ conversion from reaction with ethanol is not affected by the absence or presence of H₂ in the feed, suggesting that reaction 6 is not a significant contributor to nitrogen formation. Thus, it is believed that N₂ formation that occurs in a feed stream consisting of NO, O₂, H₂O, CO₂, H₂, CO and ethanol likely occurs from hydrocarbon SCR, where ethanol is the hydrocarbon reductant, rather than a consecutive reaction occurring between a product (NH₃) and a reactant (NO).

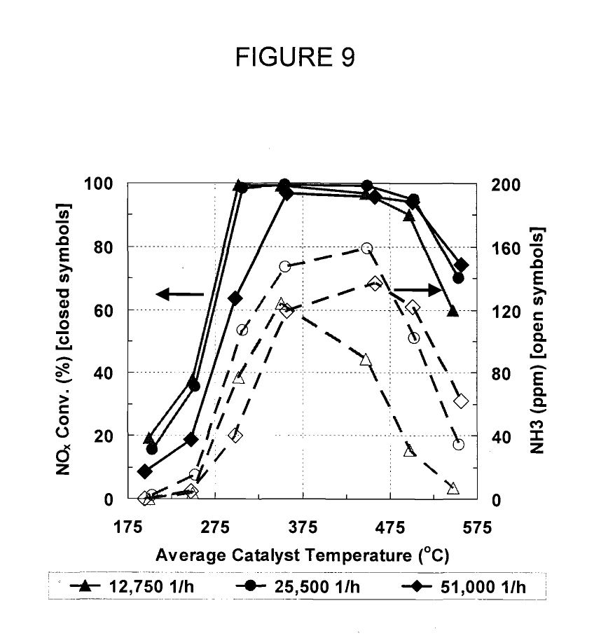

The production of NH₃ on a 3 wt % Ag₂O catalyst was assessed as a function of space velocity (total gas flow relative to catalyst volume). The gas stream was: 6% O₂, 5% CO₂, 5% H₂O, 750 ppm CO, 250 ppm H₂, 400 ppm NO, and 1724 ppm C₂H₅OH (HC₁:NOₓ˜8.6). Three space velocities were tested: 12,750 h⁻¹, 25,500 h⁻¹ and 51,000 h⁻¹. The results are shown in FIG. 9. The data indicate that the amount of NH₃ formed over the catalyst can be a function of space velocity, peaking and then declining as space velocity increases.

The results for the experiments using various mixtures of ethanol and simulated gasoline (sim-gasoline) are now presented. Sim-gasoline refers to a composition containing: 45 vol. % iso-octane, 12 vol. % 1-octane, 10 vol. % n-octane and 33 vol. % m-xylene. The mixtures used are summarized in Table 3.

TABLE 3

| Mixture name | Ethanol | Sim-gasoline |
|---|---|---|
| 0% ethanol | 0 vol. % | 100 vol. % |
| 10% ethanol | 10 vol. % | 90 vol. % |
| 20% ethanol | 20 vol. % | 80 vol. % |
| 50% ethanol | 50 vol. % | 50 vol. % |
| 85% ethanol | 85 vol. % | 15 vol. % |
| 100% ethanol | 100 vol. % | 0 vol. % |

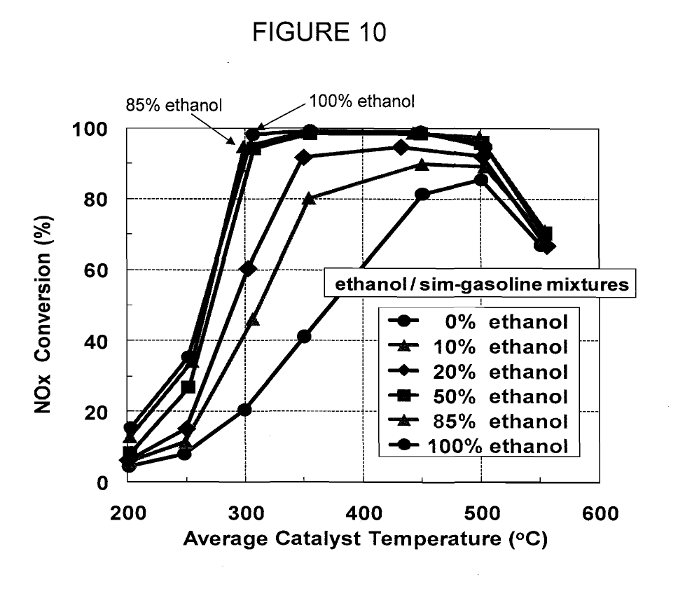

As shown in FIG. 10, NOx conversion over a 3 wt % catalyst improved as the ethanol fraction of the reductant increases. Higher temperature improved conversion for mixtures having less ethanol. At 300° C., mixtures having at least 50% ethanol approached 100% conversion. At 350° C., the mixtures containing 10 vol. % and 20 vol. % achieved ≧80% conversion, which further improved at 450° C. Conversion for all mixtures dropped off at 550° C.

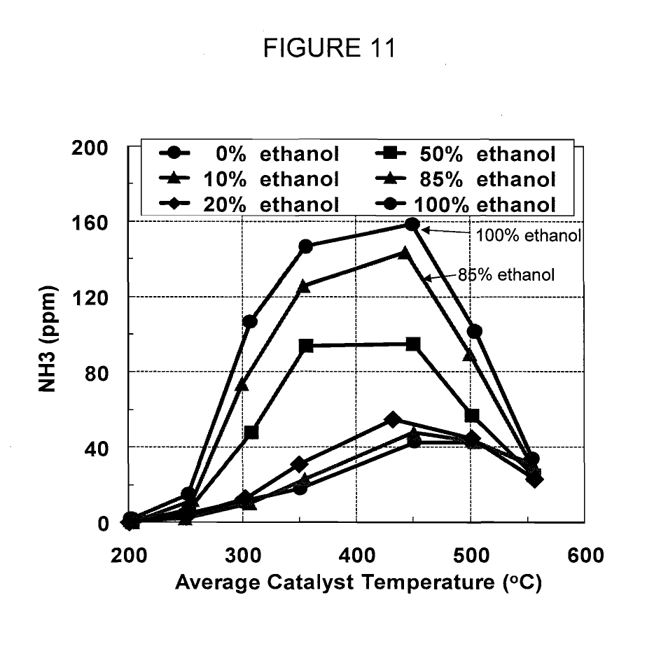

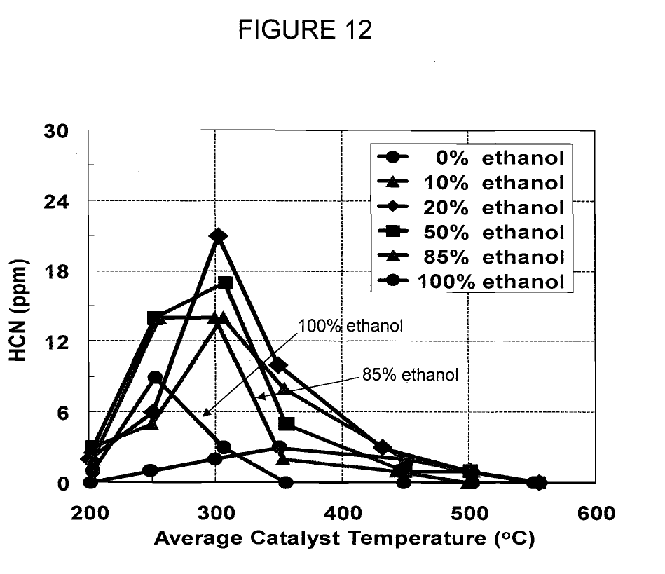

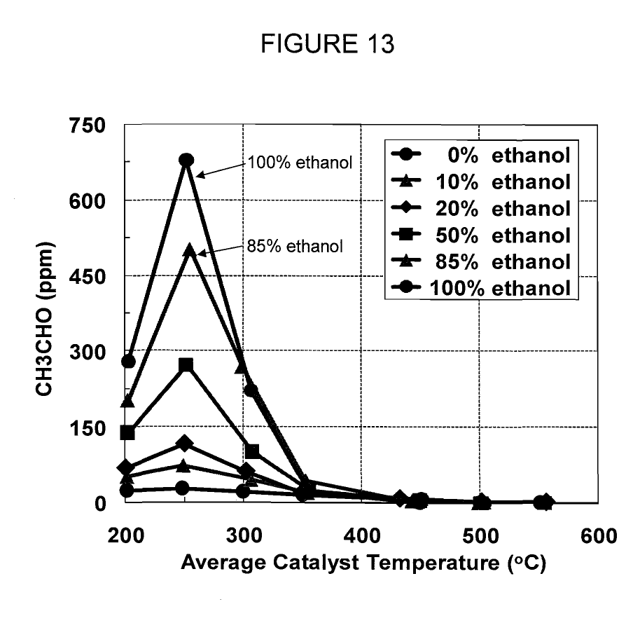

As shown in FIG. 11, ammonia production can be influenced by the amount of ethanol in the mixture. Ammonia production was greatest for the 100% and 85 vol. % ethanol mixtures. Production was particularly good from about 350° C. to 450° C. Ammonia production was much lower at all temperatures for mixtures having less than 85 vol. % ethanol. Production of cyanide generally peaked at between 250° C. and 350° C. for all ethanol mixtures and decreased to very little amounts as temperature increased (FIG. 12). At 350° C. and above, negligible cyanide was produced using the mixtures comprising at least 50% ethanol. Production of acetaldehyde was low for all mixtures at 300° C. and negligible for all mixtures at 350° C. and above, as shown in FIG. 13.

The results for the sim-diesel reductant experiments are now presented.

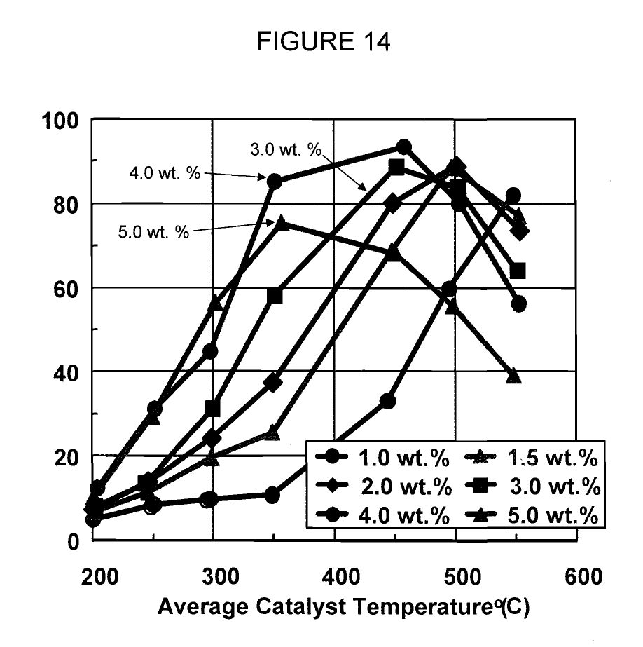

As shown in FIG. 14, the 4 wt. % catalyst catalyzed greater than 80% conversion from 350° C. to 500° C., inclusive. At 450° C., the 4 wt % catalyst catalyzed about 90% conversion of NOx. Between 450° C. to 500° C., inclusive, the 2 and 3 wt % catalyst catalyzed at least about 80% conversion of NOx. At 450° C. and above, the conversion of the sim-diesel exceeded 80% for all the catalysts except the 1 wt. % catalyst (data not shown).

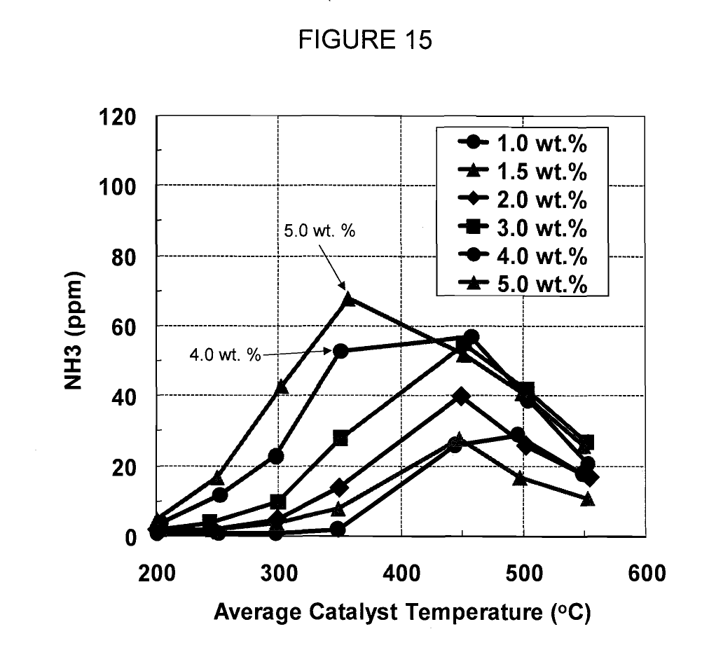

As shown in FIG. 15, all of the catalysts tested produced ammonia using sim-diesel as the reductant. The amount produced was influenced by both the wt % loading of silver on the catalyst and the temperature of the reaction. The catalysts having 4 or 5 wt % Ag₂O catalyzed a yield of at least about 12.5% NH₃ (50 ppm NH₃ produced of the 400 ppm NOx input) from 350° C. to 450° C., inclusive. The 3 wt % Ag₂O catalyst catalyzed a yield of at least about 12.5% at about 450° C. The 5 wt % Ag₂O catalyzed a yield of at least about 16% NH₃ (˜65 ppm NH₃ produced of the 400 ppm NOx input) at about 350° C.

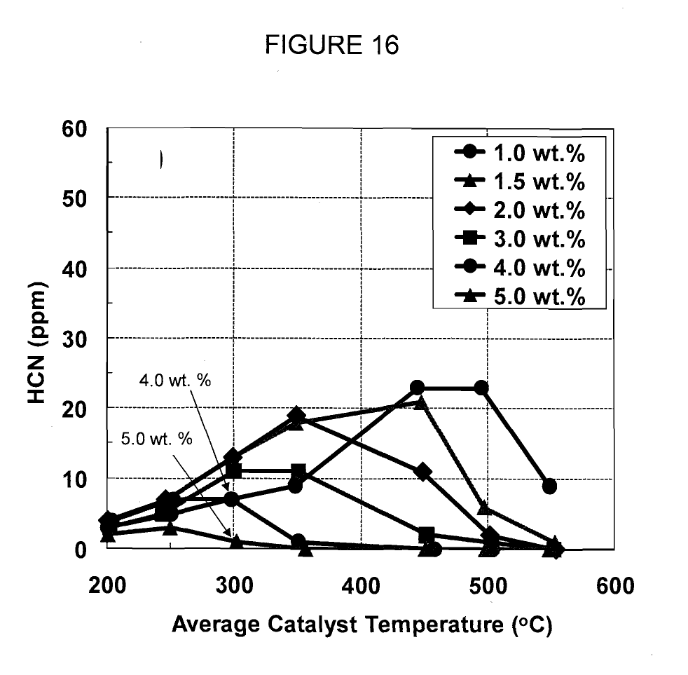

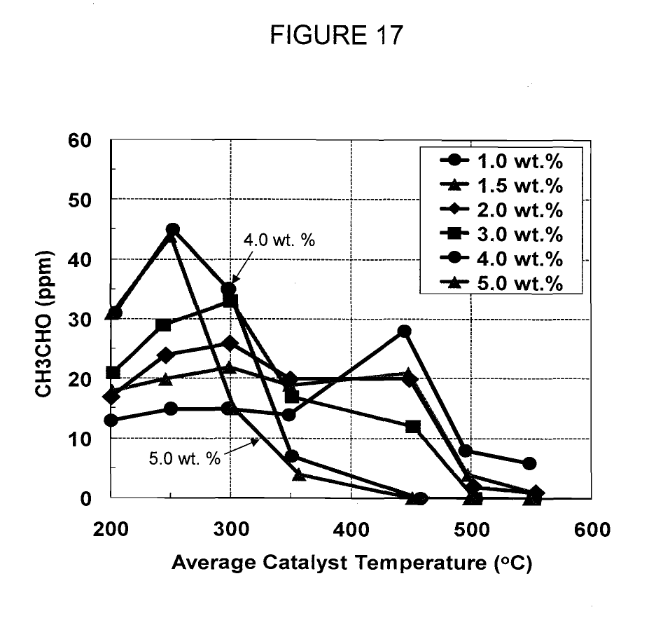

Cyanide production was fairly low at all temperatures for all the catalysts using sim-diesel as reductant (FIG. 16). In particular, the 4 wt % catalyst produced virtually no cyanide at 350° C. and above. Similarly, acetaldehyde production can be very low, particularly for the higher (4 and 5 wt %) Ag loaded catalysts at 350° C. and above (FIG. 17).

The disclosures of each and every patent, patent application, and publication cited herein are hereby incorporated herein by reference in their entirety for all purposes.

While the method has been disclosed with reference to specific embodiments, it is apparent that other embodiments and variations of the methods can be devised by others skilled in the art without departing from the true spirit and scope of the method. The appended claims are intended to be construed to include all such embodiments and equivalent variations.

What is claimed is:

1. A method for producing ammonia from a feed stream comprising nitrogen oxide (NOx), said method comprising:
contacting a feed stream comprising nitrogen oxide with a catalyst in the presence of a hydrocarbon, thereby reducing said nitrogen oxide to ammonia,
wherein said catalyst comprises silver dispersed on alumina particles and wherein the hydrocarbon is selected from the group consisting of one or more oxygenated hydrocarbons, one or more non-oxygenated hydrocarbons and mixtures thereof.

2. The method of claim 1, wherein the hydrocarbon comprises one or more oxygenated hydrocarbons.

3. The method of claim 1, wherein the hydrocarbon consists essentially of one or more oxygenated hydrocarbons.

4. The method of claim 2, wherein said one or more oxygenated hydrocarbons are selected from the group consisting of C1 to C4 alcohols and C2 diols.

5. The method of claim 1, wherein said hydrocarbon is a mixture of one or more oxygenated hydrocarbons and one or more non-oxygenated hydrocarbons.

6. The method of claim 5, wherein said non-oxygenated hydrocarbon is selected from the group consisting of n-dodecane, iso-octane, 1-octene, n-octane, m-xylene and mixtures thereof.

7. The method of claim 5, wherein said non-oxygenated hydrocarbon is selected from the group consisting of gasoline and diesel.

8. The method of claim 4, wherein said oxygenated hydrocarbon is ethanol.

9. The method of claim 1, wherein said catalyst is prepared using hydroxylated alumina.

10. The method of claim 9, wherein said hydroxylated alumina is selected from the group consisting of: boehmite, pseudoboehmite, gelatinous boehmite, diaspore, nordstrandite, bayerite, gibbsite, alumina having hydroxyl groups added to the surface, and mixtures thereof.

11. The method of claim 1, wherein said catalyst is substantially free of silver metal.

12. The method of claim 1, wherein said catalyst is substantially free of silver aluminate.

13. The method of claim 1, wherein said catalyst comprises about 2 wt % to about 4 wt % silver on a Ag₂O basis.

14. The method of claim 1, wherein at least about 25% of nitrogen oxide is reduced to ammonia.

15. The method of claim 1, wherein said contacting step occurs at a temperature from about 200 degrees centigrade to about 500 degrees centigrade (° C.).

16. The method of claim 1, wherein the ratio of oxygenated hydrocarbon to nitrogen oxide (HC₁:NOₓ) is at least about 2.2.

17. The method of claim 9, wherein calcination of said silver dispersed on said hydroxylated alumina yields silver dispersed on gamma alumina.

18. The method of claim 1, wherein said contacting of said catalyst occurs with a space velocity from about 12,750 h⁻¹ to about 51,000 h⁻¹.

19. The method of claim 1, wherein the feed stream further comprises oxygen, carbon dioxide, and water.

20. The method of claim 19, wherein the feed stream further comprises carbon monoxide and hydrogen.
